(19) United States
(12) Patent Application Publication
(10) Pub. No.: US 2006/0218614 A1
(43) Pub. Date: Sep. 28, 2006

(54) Educational television broadcast system

(76) Inventor: Joseph Louis Lovell, Nashville, TN (US)

Correspondence Address: Joseph L. Lovell, 605 Rivercrest Way, Nashville, TN, 37214, US

(21) Appl. No.: 11/087,792

(22) Filed: Mar. 23, 2005

(51) Int. Cl. H04N 7/173

(52) U.S. Cl. 725/110; 725/100; 725/109; 725/112; 725/131

(57) ABSTRACT

An educational live television broadcast system is provided which provides a virtually inexhaustible array of subject matter for students who have access to television sets. The programming is provided on a pay-per-view basis and presents those students all over the world who have access to television with a wide variety of instructional courses presented by the finest authorities in their respective fields. Cable and/or satellite television, as appropriate, may be employed to provide the system of the instant invention and, depending upon the students' needs, interactivity may be supplied between the student and the teaching authority during these broadcasts.

### I. FIELD OF THE INVENTION

This invention relates to an educational television broadcast system and more specifically to selected courses or curricula available from a television broadcast network which includes a wide-ranging selection of educational courses to be selected by a user or student.

In the civilized world, in order to instruct children starting at age five, there have been developed both public and private school systems which instruct the child or student generally at tracks according to their ability through high school, with the requisite knowledge either on to college or to go into the workplace. In the workplace, the student may entertain further course work with regard to a trade, sales, marketing or the like to receive accreditation and certification. For the student who chooses the college path, the appropriate course work is selected according to the preferences of the student and the student's demonstrated ability to pursue a bachelor's degree or equivalent and further on to masters and PhD degrees.

Students in the workplace are encountering ever-increasing inconvenience and escalating fees to complete this course work and be certified in various trades and occupations. College students are experiencing astronomical increases in tuitions and, in most cases, are faced further with escalating prices in supplies and room and board. Correspondence courses have been made available to pursue various and sundry trades in addition to degrees at the bachelor, masters and, in some cases, PhD level. With the advent of the computer, many of these correspondence courses have been provided on line for fixed fees and, in most cases, with accreditation in the various trades and professions sought. In general, this is the method of instruction pursued in today's modern civilized world.

Various interactive education systems have been provided; for example, in U.S. Pat. No. 6,775,518 there is disclosed an interactive educational system simultaneously providing educational materials to multiple users. The educational system tests and records each user's demonstrated comprehension of the materials provided. The server-based system can provide materials that are data, video data, or audio data. The user may input video, audio or other data. Each user can randomly access the precise location of the educational materials or portion thereof to be presented to the user. This system contemplates a central operations, including a processor, a storage and an input/output device for providing interaction between the system and an administrator, wherein the interaction including capture of content to be stored in the storage, a network I/O, a modem, telephony I/O, an audio/video I/O, and a plurality of terminals for multiple users to receive the educational materials provided which include a telephonic user interface for upstream control, and a video channel for downstream presentation of said educational materials, and a plurality of bi-directional communications channels are employed whereby the central operations communicates with each of the plurality of terminals through the plurality of communication channels so that the multiple users interact with the terminals to communicate with the central operations and the central operations provides the multiple, simultaneous users random access to the educational materials. Further included in at least one of the bi-directional communications channels a telephony channel in an upstream direction and a video channel in a downstream direction.

In an exemplary embodiment described in U.S. Pat. No. 6,775,518, the interactive educational system described comprises a server including permanent memory, a first communications channel, and a terminal for a student to receive educational materials. The materials are stated to include data, video and/or audio presented materials and the communications channel is recited to be bi-directional providing the server communication with the terminal and the ability of the user to interact with the terminal to communicate with the server. In this case the terminal is stated to be a computer with a processor, a monitor, and a user controlled input device, such as a keyboard, a pointing device, a camera, or a microphone. In this embodiment, the first communications channel may be an Internet communications channel. The interactive educational system may further include multiple user terminals, each of which provide random access to the educational materials. Multiple users may access the precise location for materials which the particular user desires from the educational materials stored by the server. The server prompts each of the separate users to demonstrate their comprehension of the educational materials used by that user or student so that the server can evaluate the correctness of the user's responses and re-present relevant portions of the educational materials to the student when the student fails to demonstrate adequate comprehension of the materials. In this case, a server is employed which includes a writeable/rewriteable memory where each of the users' responses are recorded in the memory.

Thus it is seen in U.S. Pat. No. 6,775,518 that an approach to solve the obvious drawback of lack of interaction of students with a videotape presentation is provided. The interactivity contemplated in U.S. Pat. No. 6,775,518 appears to remedy the inability of videotaped systems to provide a means to test the user and provide instantaneous feedback or provide response dependent reinforcement of the subject material.

In U.S. Pat. No. 5,625,845 a data processing system is provided for executing multimedia applications which interface with multimedia end devices that consume or produce at least one of real-time and asynchronous streamed data. The data processing system includes a central processing unit, a digital signal processor, and a plurality of modular components. Thus there is provided a system for sharing data streams, control signals and variable signals between software tasks and multimedia end devices, in addition to sharing data streams, control signals and variables in a digital signal processor which interfaces with a data processing system.

Various other interactive education systems are known. For example, in U.S. Pat. No. 6,758,676 an interactive education system directed to teaching patient care is provided; in U.S. Pat. No. 6,749,432 an education system challenging a subject's physiologic and kinesthetic systems to synergistically enhance cognitive function is provided; further interactive education systems to teach patient care provided in U.S. Pat. No. 6,527,558 and U.S. Pat. No. 6,503,087.

Various authors have written with regard to interactive education and the impact of the Internet on learning and teaching, including Professor Hossein Arsham. His articles and web page describe how to operate and make web-based courses successful and enjoyable. Professor Arsham states that contrasted to face-to-face settings where the responsibilities are ranked with emphasis on the teacher's capability rather than learning, when employing online courses the emphasis is more on learning than teaching. Arsham recounts that in the last 30 years with the advent of the desktop computer and the Internet, there was an accompanying prediction of a significant impact on traditional classroom programs. Arsham points out, however, that similar innovations or “dawns”, as he puts them, throughout the 20^{th} century, including film, radio, records, broadcast television, audiotape, videotape, programmed learning machines, and the like, each have caused enthusiasts to announce the transformation or the end of the traditional school/college/university system of learning. However, as is witnessed today, the impact of all of these innovations has merely served to supplement or enhance the so-called school/college/university learning and teaching system. In fact, with regard to graduates of online courses, it is stated that employers are likely to be cautious, if not skeptical, since most employers have traditional degrees and may not greet these online graduates with great credibility. Various universities have found ways to bring the benefits of the classroom into distance learning settings, which unfortunately have been characterized as industrialized forms of education because of the rationalization of process, division of labor and mass production.

Despite the advent of universities and colleges seeking different avenues to increase revenues, including the untapped market of employing online programs, since the dawn of the Internet its so-called miracle, has not allowed great teachers to reach any student on any subject any time and anywhere.

It is well recognized that the highest cost component of quality instruction is the cost associated with capable, competent faculty. Attempts to substitute less experienced, consequently lesser quality, instructors such as graduate teaching assistants, adjunct and part-time faculty, has been employed for decades and has reduced the cost of instruction but consequently has also reduced the quality of instruction.

### II. OBJECTS OF THE INVENTION

Thus there is seen a demonstrated continuing need to employ modern day technologies in the furtherance of effectively providing education to students in a wide range of subjects, including those that require certification and those that require degrees and advanced degrees, devoid of the above noted deficiencies.

It is an object of this invention to provide an educational television broadcast system which broadcasts live student-selected curricula to a location of a student's choice on a pay-per-view basis.

A further object of this invention is to create and supplement an educational television broadcasting network that will accommodate both degree programs, from associate through PhD, as well as trade certification.

Still a further object of this invention is to provide students, on a pay-per-view basis, access to the finest professors in a given field through live television.

Yet another object of this invention is to provide the highest quality instruction in a most convenient and expeditious manner at the lowest possible price.

Still another object of this invention is to simulate the classrooms of the most prestigious organizations in the country and provide them to convenient and remote locations at the request of students.

Yet again another object of this invention is to provide interactive pay-per-view educational courses.

### III. SUMMARY OF THE INVENTION

These and other objects of the instant invention are accomplished generally speaking by providing an educational television broadcast system which presents student-selected live educational television broadcasts which may be accessed on a pay-per-view basis. In its initial adaptation, for example, this system may comprise live educational broadcasts from prestigious universities on a pay-per-view basis. Ultimately, it is contemplated that an exhaustive educational television broadcast network will be provided to satisfy the needs of both certification and degree programs. In its simplest adaptation, a student accesses the pay-per-view live television educational broadcast through a terminal. The classroom simulation may be further enhanced by employing certain interactive means allowing the student to interact with the live television broadcast. In a preferred embodiment, this would comprise the Instant Message capability of the Internet during the broadcast, during which significant questions, including presumably those of the student, would be offered up to the professor during the live broadcast for his comment. Unlike the traditional classroom setting, it is anticipated that the student accessing through pay-per-view will be encouraged to propound questions because of the student's anonymity.

It is contemplated that in addition to the conventional student body, individual corporate and non-corporate students, including senior citizens, will find this a very attractive system since they do not have to deal with soaring tuition expenses, travel and living expense, distance from major metro areas where they would receive these courses, and time away from a job, where employed, which creates increased costs. The system of the instant invention has the potential to revolutionize the civilized world's view of degree education and training for certification. The finest instructors in the world could ultimately comprise the backbone of this educational live broadcast television network, substantially reducing the costs and allowing attendance with the simplicity involved in turning on their television, properly equipped, and perhaps a terminal. In recent Congressional testimony regarding American job losses to foreign countries, Alan Greenspan, Chairman of the Federal Reserve Board, stated “Anything that we do to enhance the skill level of the American workforce is crucial to our long term development and the stability of our society.” He thereafter suggested that it would be fruitful to consider reforms in the education system to insure that workers with the required technical skills be made available in the marketplace. The system of the instant invention is directed to precisely this goal and objective.

Any suitable live educational television broadcast network may be employed in the system of the instant invention. Typically, either cable television networks or satellite television networks such as DirecTV may be employed whose present educational programming, if any, is to be supplemented to provide a wide range of subject matter applicable to meet the needs of students from the very earliest grades up through the bachelors degree level and advanced degrees, in addition to certifications in a wide variety of trades. Initially, for example, in the college and university arena with regard to the pursuit of any profession or career, the finest professors for a given subject may be chosen for live television broadcast pay-per-view. This may be accomplished in any suitable manner; however, typically it is anticipated that the university or college campus classroom would initially be simulated with or without interactive means employed by the student.

Since the cost of instruction is by far the most significant in the soaring tuition rates experienced across the United States and elsewhere, this will provide a forum for prestigious professors to reach large audiences of students in addition to or in substitution of the regular college or university class size, thus driving the most significant increase in tuition drastically downward. In addition, after initially selecting a given instructor for his expertise and teaching skills the student body will automatically gravitate towards the finest professors by selecting their courses. Thus this system, in addition to driving down costs dramatically, essentially optimizes the delivery of instruction through the finest professors irrespective of the size of the audience. Essentially there is no limit to the study body that can be reached conveniently in civilized countries employing cable television or in third-world countries employing satellite television.

Any suitable pay-per-view system may be employed in the system of the instant invention. Typical systems include those currently employed in connection with both live and videotaped broadcasts in both cable television and satellite television systems currently available. Typically, pay-per-view systems may also embrace volume discount scenarios where a degree and/or certification is pursued, further driving down the costs on a volume basis.

Any suitable terminal may be employed to access the live educational broadcast television system of the instant invention. Typical terminals include set top boxes employed in currently available cable television or satellite television broadcast systems. These terminals may be ultimately modified to accommodate the increased offerings in addition to the charges whether initially incurred on a pay-per-view basis or ultimately on a volume discounted basis.

Any suitable interactive device or system may be employed in interrogating and/or interacting with the live educational television broadcast system of the instant invention. Typical methods include smart and semi-smart terminals including Webmaster, PCs employing fax or e-mail, in addition to using the telephone with 800 numbers during said broadcast. Questions however received during the live broadcast may be prioritized according to their significance by staff at the broadcast and submitted to the professor to answer in real time during the broadcast. Questions not answered during the broadcast may be answered after the broadcast presentation employing either of the methods recited above or any other suitably stipulated system which satisfies the students' needs.

Although it is anticipated that the selected programming will be offered and scheduled during those periods of time that the largest audience may be reached, there may be cases where a student misses the appointed time. In those cases, the instant system will be supplemented by an on-demand system such as is currently employed by, for example, Spectravision and others where movies are called up on demand and the requested programming will be viewed by the student and, in these cases, a further schedule will be supplied whereupon aids or the professor himself will be available at a given location to interact with the students who are now interrogating a video of the live presentation.

While the present invention has been particularly described with respect to a preferred sequence of process steps in the system of the instant invention, it will be understood that the invention is not limited to the process steps or the sequence as described in the specification. On the contrary, it is intended to cover all alternatives, modifications, and equivalents as may be included within the spirit and scope of the invention defined by the appended claims.

For example, it is anticipated that interactivity will increase by virtue of anonymity, among other reasons, so that extensive use of voice over IP or video broadcasting adaptations into the broadcast center may be employed if the student wishes, at an additional charge.

Other applications will become apparent to those skilled in the art with regard to the application of the educational system of the instant invention. The distinct advantage of live broadcasts from an educational network makes it particularly applicable to home schooling which has found widespread acceptance across the United States, and since the participants are made aware, if not requested to do homework with regard to the live broadcasts, they may submit questions prior to the broadcast which will modify and alter the presenter's dissertation in accordance with their interests and questions which is absent in all taped educational replays whether they are broadcast or not. As previously recited, if interactivity simulating that in a classroom is required, it may be accomplished online, by e-mail, instant messaging or by fax or telephone during the broadcast. Those questions not answered during the live broadcast, as previously recited, may be answered during a rebroadcast or, in the case of a continuing course, may be compiled according to interest or significance of the question and answered and explained during a subsequent broadcast. The system of the instant invention, in addition to courses leading to certification or degrees, is especially applicable to teaching sports, cooking, languages and the like.

The system of the instant invention is intended to employ any suitable mechanism for broadcasting its program content including using the pay-per-view television network as its backbone or a supplemented and/or newly created dedicated educational television network on a pay-per-view basis.

What is claimed is:

1. An educational live television broadcast system, comprising:
(a) an educational television broadcast network which provides live educational broadcasts; and
(b) a user terminal which accesses said network on a pay-per-view basis.

2. The system as defined in claim 1, wherein said system further comprises a communication device which provides interactivity between the student and a presenter providing the educational broadcast.

3. The system as defined in claim 2, wherein said communication device comprises an instant messaging system as employed on an Internet system.

4. The system as defined in claim 2, wherein said communication device is selected from a group consisting of e-mail, fax machine inquiries, and/or telephonic inquiries.

5. The system as defined in claim 1, wherein said system is implemented by employing either cable television or satellite television systems.
